(19) United States
(12) Patent Application Publication
(10) Pub. No.: US 2020/0136533 A1
(43) Pub. Date: Apr. 30, 2020

(54) AUTONOMOUS ELECTRIC GENERATOR FOR PRODUCTION OF RENEWABLE, CLEAN, PORTABLE, AND SUSTAINABLE ENERGY

(71) Applicants: Ock Kee BAEK, Markham (CA); KE TECHNOLOGY., LTD, Bucheon-si (KR)

(72) Inventors: Ock Kee BAEK, Markham (CA); Gang Soo LEE, Bucheon-si (KR)

(21) Appl. No.: 16/209,003

(22) Filed: Dec. 4, 2018

Related U.S. Application Data
(63) Continuation of application No. PCT/KR2018/012877, filed on Oct. 29, 2018.

(51) Int. Cl. H02N 11/00; H02K 11/02; H02K 1/12; H02K 1/27; H02J 7/34

(52) U.S. Cl. CPC H02N 11/002; H02K 11/02; H02J 7/34; H02K 1/27; H02K 1/12

(57) ABSTRACT

Provided is an autonomous electric generator including: a stator includes generator coil for generating electricity and motor coil for generating electromagnetic force; a primary rotator includes a first permanent magnet; and a secondary rotator includes a second permanent magnet. The primary rotator and secondary rotator are rotated by the electromagnetic force generated by the motor coil. The autonomous electric generator is to generate renewable, portable and sustainable energy, using a self-sufficient electric generator that produces electricity from naturally abundant resources in a self-sufficient and sustainable method. The autonomous electric generator does not cause any harmful impacts to the environmental ecosystem or to the human health.

### TECHNICAL FIELD

This present invention is generally related to the approach, article, method, model, design, apparatus, and system for generation of electric energy from such as nuclear fusion, sunlight, wind, rain, tides, waves, and geothermal heat, as well as the traditional hydroelectricity and fossil-burning thermal power generation.

### BACKGROUND ART

Our daily lives are heavily dependent upon electricity. Any unplanned power outages lead to disastrous consequences and often leads to life-and-death situations.

Continuous supply of reliable electricity without any disruption at any time under any circumstances is essential and critical to the human civilization. And yet, there are many challenges in meeting this requirement in a sustainable manner.

The conventional power generation method is not sustainable due to the rising cost and the diminishing resources.

The current fossil-burning electric generators pollute the environment and thus hazardous to human health.

Nuclear power plants may not pollute the air but the risks associated with an operational error or an accident are extremely high and the impacts on the environment are not only disastrous but also last for very long period of time, i.e., hundreds of years.

In addition to the challenges associated with generation of electricity, distribution of electricity is not only costly but also unreliable due to the dependencies on the environmental variables and the weather conditions.

There are new demands and requirements in this information age with knowledge-knowledge-based economy. Mobile devices such as IOT (Internet of Things) and cyber physical systems involving specialized robots and drones require portable energy sources that do not require power cords or transmission lines.

Batteries are used as the portable energy sources to address those new requirements. However, the batteries are bulky and heavy and also must be recharged.

This present invention is to address those challenges, shortcomings, risks, and new requirements by providing a novel method and system for generation of the renewable and portable energy in a clean (neither impacting the environmental ecosystem nor being hazardous to human health) and sustainable method.

### DISCLOSURE

### Technical Problem

The primary goal of this present invention is to generate a renewable, portable, and sustainable energy, using an autonomous electric generator that generates electricity from naturally abundant resources in a self-sufficient and sustainable manner.

An additional goal is to ensure that the energy generation method, apparatus, or system does not cause any harmful impacts to the environmental ecosystem in any way.

Another goal is to generate a portable energy so that the generated electricity can power remote houses or manufacturing plants in isolated areas or any mobile devices without requiring power transmission and distribution.

The other goal is to ensure that the energy generation method is sustainable for years without requiring any external resources.

This present invention introduces an approach, method, model, design, and system to generate electricity from a set of electric generators that are paired with a set of corresponding electric motors, which are powered by a portion of the generated electricity.

In this present invention, a portion of the newly generated electricity is used to charge a set of electric capacitors through the loop-back mechanism so that the electric motors are continued to be powered by the electricity stored in the capacitor. This way, the electric generators continue to run autonomously, once started, without requiring any external resources.

This present invention introduces an approach, method, model, design, and system to amplify the electricity by trapping the electromagnetic forces between the shields of iron plates and consequently inducing hypertension and pulsation of the electromagnetic energy.

In this present invention, the magnetic lines of force on one side of the conductor (e.g., a copper plate) are running in the opposite direction to the magnetic lines of force surrounding the conductor. Consequently, the magnetic lines of force are deflected so that the magnetic lines of force may pass on the other side of the electrical conductor. This is because the magnetic lines of force cannot cross or run contrary to each other.

### Technical Solution

The present invention is to generate renewable, portable and sustainable energy, using a self-sufficient electric generator that produces electricity from naturally abundant resources in a self-sufficient and sustainable method. This present invention ensures that the energy generation method, apparatus, or system does not cause any harmful impacts to the environmental ecosystem or to the human health; that the generated energy is portable so that the electricity can be used to power remote houses or manufacturing plants in isolated areas or any mobile devices without requiring power transmission and distribution; and that the energy generation is sustainable for years without requiring any external resources.

This present invention introduces an approach, method, model, design, and system to integrate a set of electric generators and a set of corresponding electric motors, where a portion of the newly generated electricity is used to power the electric motors through a loop-back mechanism.

This present invention introduces an approach, method, model, design, and system to amplify the generated electric energy by trapping the electromagnetic forces between the shields of iron plates and consequently inducing hypertension and pulsation of the electromagnetic lines of force.

This present invention also introduces an approach, method, model, design, and system to further amplify the generated electric energy through precession of quantum momentum of neutrons and protons by applying an oscillation frequency that matches the intrinsic quantum property of the angular momentum of the isotopes that contain an odd number of neutrons and/or protons. This method and system enables the magnetic nuclei to absorb the oscillation energy by placing the nuclei in a strong magnetic field and applying the oscillation frequency in resonance with that of the nuclei. Consequently, the perturbed magnetic fields of a great strength produce large currents in the copper plates.

This present invention uses a set of rechargeable battery to regulate the generated electricity and ensure the quality of the generated electricity in a self-sufficient and sustainable method for a long time period, e.g., several years.

### Advantageous Effects

This present invention introduces an approach, method, model, design, and system to integrate a set of electric generators and a set of corresponding electric motors, where a portion of the newly generated electricity is used to power the electric motors through a loop-back mechanism.

This present invention introduces an approach, method, model, design, and system to amplify the generated electric energy by trapping the electromagnetic forces between the shields of iron plates and consequently inducing hypertension and pulsation of the electromagnetic lines of force.

This present invention also introduces an approach, method, model, design, and system to further amplify the generated electric energy through precession of quantum momentum of neutrons and protons by applying an oscillation frequency that matches the intrinsic quantum property of the angular momentum of the isotopes that contain an odd number of neutrons and/or protons. This method and system enables the magnetic nuclei to absorb the oscillation energy by placing the nuclei in a strong magnetic field and applying the oscillation frequency in resonance with that of the nuclei. Consequently, the perturbed magnetic fields of a great strength produce large currents in the copper plates.

This present invention uses a set of rechargeable battery to regulate the generated electricity and ensure the quality of the generated electricity in a self-sufficient and sustainable method for a long time period, e.g., several years.

### DESCRIPTION OF DRAWINGS

FIG. 1 is a diagram depicting the key components, their functional properties and their relationships in one embodiment of the present invention disclosure.

FIG. 2 is a diagram illustrating a horizontal slice of the apparatus and system and depicting the top view of the apparatus and system in one embodiment of the present invention disclosure.

FIG. 3 is a diagram depicting the side views of the implementation variants with various number of cores (e.g., 6 cores, 9 cores, and 12 cores) of the apparatus and system in one embodiment of the present invention disclosure.

FIG. 4 is a diagram depicting the 3-dimensional view of an implementation variant with 9 cores of the apparatus and system in one embodiment of the present invention disclosure.

### MODE FOR INVENTION

Hereinafter, embodiments of the present invention will be described in more detail with reference to the accompanying drawings, in order to allow those skilled in the art to easily realize the present invention. The present invention may be realized in different forms, and is not limited to the embodiments described herein. Moreover, detailed descriptions related to well-known functions or configurations will be ruled out in order not to unnecessarily obscure subject matters of the present invention. Like reference numerals refer to like elements throughout.

In additional, when a part “includes” some components, this means that the part does not exclude other components unless stated specifically and further includes other components.

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

Although most terms used in the present invention have been selected from general ones widely used in the art, some terms have been arbitrarily selected by the applicant and their meanings are explained in detail in the following description as needed. Thus, the present invention should be understood based upon the intended meanings of the terms rather than their simple names or meanings.

Through a repeated searches for the related prior arts, the inventors of this present invention have found quite a few articles and systems related to the magnetic generators, as well as wide variety of newspaper articles and video clips.

This present invention generates a renewable and portable energy without requiring any external resources, in a sustainable manner, by integrating a set of electric generators with a set of corresponding electric motors within an apparatus or system to power the electric motors with a portion of generated electricity via a loop-back mechanism.

In this case, the electric motors are started by the electricity from the capacitor to create kinetic energy, which is used by the electric generators to produce electricity. A portion of the newly generated electricity is used to charge the electric capacitor through the loop-back mechanism; the electric motors are then continued to be powered by the electricity stored in the capacitor so that the electric generators may continue to run autonomously, once started, without requiring any external resources.

This present invention amplifies the generated electric energy, by condensing the magnetic lines of force within the compactly shielded spaces and triggering the electromagnetic hypertension and pulsation; and by creating the nuclear magnetic resonance with the oscillation frequency that matches the intrinsic frequency of the nuclei and thus enabling the precession of the quantum nuclear momentum.

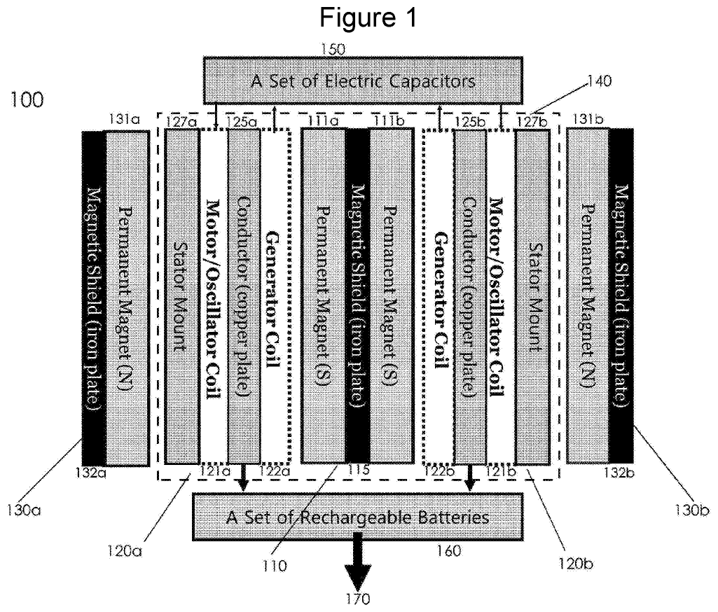

An autonomous generator implemented based on the present invention is depicted in FIG. 1 at a conceptual level.

An autonomous generator according to an embodiment of the present invention includes a primary magnetic rotor 110, secondary magnetic rotors 130a and 130b, stators 120a and 120b, a set of electric capacitors 150 and a set of rechargeable batteries 160. In one embodiment, the primary magnetic rotor 110, the secondary magnetic rotors 130a and 130b, and the stator 120a and 120b may be connected by a single shaft.

The primary magnetic rotor 110 may include permanent magnet 111a and 111b, and a magnetic shield 115. The secondary magnetic rotors 130a and 130b may include permanent magnet 131a and 131b, and magnetic shields 132a and 132b.

The stator 120a and 120b may include motor coil 121a and 121b, generator coil 122a and 122b, conductor 125a and 125b, and stator mount 127a and 127b. The stator 120a and 120b further include shield unit to shield the electromagnetic lines of force the separation of concern between the motor coil 121a and 121b and the generator coil 122a and 122b.

As depicted in FIG. 1, an autonomous generator 100 comprises a set of permanent magnets (111a, 111b, 131a, 131b) based on the alloy of neodymium (Nd2Fe14B) and a set of iron plates (115, 132a, 132b) that provide the magnetic shields. The permanent magnets and corresponding iron plates are used as the primary magnetic rotor 110 and the secondary rotors (110, 130a, 130b) for induction of electricity.

The primary magnetic rotors 111a and 111b are rotated by the S-polarized electromagnetic forces created by the motor coils 121a and 121b.

The secondary magnetic rotors 130a and 130b are rotated by the N-polarized electromagnetic forces created by the motor coils 121a and 121b.

The magnetic rotors (110, 130a, 130b) are rotated by the magnetic forces created by the motor coils 121a and 121b which are powered by a set of capacitors 150 with a portion of the electricity generated by the generator coils 122a and 122b.

Here, the initial rotation of the magnetic rotor can be performed by the power supplied from the rechargeable battery 160. Since the current for the motor coil 121a and 121b is generated by the rotation of the magnetic rotors, a power source is required at the initial rotation when the magnetic rotor is not rotating. The rechargeable battery 160 serves as a power source at start-up.

Therefore, when the rechargeable battery 160 provides electricity to the motor coil 121a and 121b, the magnetic rotors rotate by the magnetic field generate by the motor coil. When the magnetic rotor starts to operate, electricity is generated in the generation coil 122a and 122b, and the generated electricity is transmitted to the motor coil 121a and 121b through the capacitor to generate a magnetic field for rotating the magnetic rotors 115, 130a and 130b.

The capacitor 150 stores and re-emits the power generated by the power generation coil to ensure stable operation of the entire generator.

The rechargeable battery 160 stores power generated in the power generation coil and outputs it to an external system. The battery 160 may serve as a buffer so that the power can be output stably.

The iron plate of the secondary rotors 132a and 132b and the iron plate of the primary rotor 115 create two compactly shielded spaces of magnetic fields to create the condensed magnetic lines of forces between the magnetic shields (132a and 115; 115 and 132b).

An external magnetic field is applied with the motor coil horizontally to the current magnetic field that is created by the permanent magnets within the compactly shielded spaces (between 132a and 115, and 132b and 115), and consequently the two magnetic fields interact each other to form an imaginary magnetic line of force.

The magnetic lines of force in the electrical conductor to form a concentric circle around the electrical conductor (the copper plates in the current implementation, 125a and 125b) so that the magnetic lines of force in the externally applied magnetic field may run in parallel lines.

Since the magnetic lines of force on one side of the conductor (the copper plates in the current implementation, 125a and 125b) are running in the opposite direction to the magnetic lines of force surrounding the conductors, they are deflected so that the magnetic lines of force may pass on the other side of the electrical conductors. This is because the magnetic lines of force cannot cross or run contrary to each other.

The compactly shielded spaces of magnetic fields trigger the electromagnetic hypertension and pulsation and consequently boost the electromagnetic forces for induction of amplified electric energy for the generator coils 122a and 122b and the electric conductors, i.e., copper plates 125a and 125b.

Consequently, a large number of magnetic field lines are trapped in a small space between the electrical conductors. This magnetic field is now mostly unopposed and therefore its build-up or expulsion in one direction to create an amplified electromagnetic force. In this case, the amplification factor of the generated electricity will be in the order of where m depends on the strength of magnetic forces, the conducting rate of the electric conductors, and the surface of the conductors.

Smoothly polished ball bearings are used for the rotation axes of the stators (120a, 120b) to minimize the frictions caused by rotation and also the additional kinetic forces caused by the trapped magnetic forces within the compactly shielded spaces (between 132a and 115, and 132b and 115). A ball bearing (not shown) may be provided between the rotor and the rotary shaft.

The nucleons, i.e., neutrons and protons, of the isotopes (e.g., 57Fe, 11B, 1H) have the intrinsic quantum property of an intrinsic angular momentum accordingly with the Quantum Physics. All isotopes that contain an odd number of protons and/or neutrons have an intrinsic nuclear magnetic moment and angular momentum.

The nuclei in a strong static magnetic field are perturbed by an oscillating magnetic field and the perturbed magnetic fields respond by producing an electromagnetic signal with a frequency characteristic of the magnetic field at the nucleus.

The magnetic nuclei absorb the oscillation energy when placed in a magnetic field and the oscillation frequency is in resonance with that of the nuclei. Consequently, the perturbed magnetic fields of a great strength produce large currents in superconducting coils or plates.

In order to exploit the characteristics and intrinsic properties of Quantum Physics, neodymium-based permanent magnets (131a, 111a, 111b, 131b) are used to place the nuclei of the iron isotopes (132a, 115, 132b) in a strong magnetic field; the motor coils (121a, 121b) are then used to generate the oscillating frequency that matches the intrinsic quantum property of the angular momentum of the isotopes (57Fe) and thus enabling the precession of the quantum nuclear momentum.

Through the precession of the quantum nuclear momentum and the nuclear magnetic resonance, the low-energy nuclei in the iron isotopes absorb the oscillation energy and flip the spin axis accordingly with the electromagnetic polarization, which perturb the magnetic fields of a great strength and produce large electric currents in conducting plates (125a and 125b). In this case, the amplification factor of the generated electricity will be in the order of 10n where n depends on the strength of magnetic forces, the conducting rate of the electric conductors, and the surface of the conductors.

This implementation of the present invention shows a configuration comprising one primary rotor and two secondary rotors and associated stators, for an illustration and explanation of the concepts. There is no architectural limitation to expand the configuration for multiple primary rotors and corresponding sets of secondary magnetic rotors.

The apparatus and system of this present invention comprises a set of embedded rechargeable battery that regulates the generated electricity and ensures the quality of the generated electricity in a self-sufficient and sustainable manner for an extended period of time without dependency on any external resources (e.g., 10 years).

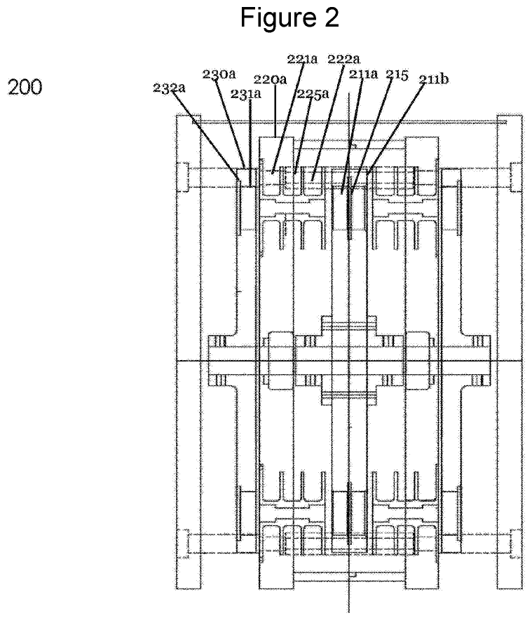

The top view of the apparatus and system (200) in one embodiment of the present invention is depicted in FIG. 2, where the numbers of the comprising components correspond to the numbers of the components in FIG. 1. For example, the comprising component (230a) in FIG. 2 is the secondary rotor (130a) in FIG. 1.

The comprising component 232a in FIG. 2 maps to the component 132a in FIG. 1; the component 230a in FIG. 2 maps to the component 130a in FIG. 1; the component 231a in FIG. 2 maps to the component 131a in FIG. 1; the component 220a in FIG. 2 maps to the component 120a in FIG. 1; the component 215 in FIG. 2 maps to the component 115 in FIG. 1; and so on.

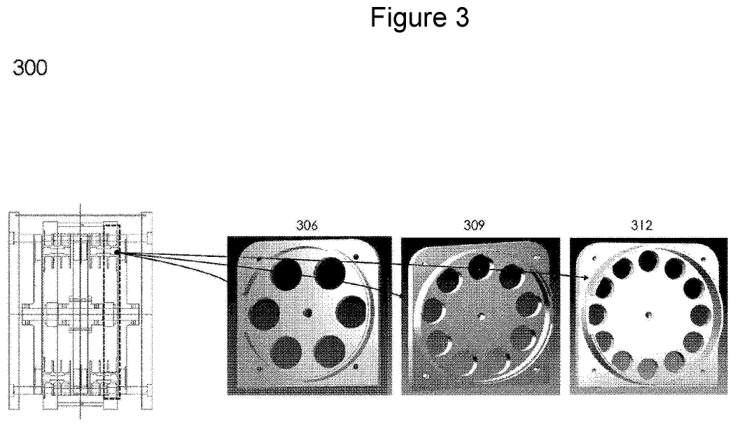

Some variants of implementation of the present invention to further amplify the generated electricity are shown in FIG. 3 (300). A configuration with 6 cores (306) comprises 6 sets of the motor/oscillator coil (e.g., 121a or 121b in FIG. 1), the copper plate (e.g., 125a or 125b in FIG. 1), and the generator coil (e.g., 122a or 122b in FIG. 1) for a stator (e.g., 120a or 120b in FIG. 1).

A configuration with 9 cores (309) comprises 9 sets of the motor/oscillator coil (e.g., 121a or 121b in FIG. 1), the copper plate (e.g., 125a or 125b in FIG. 1), and the generator coil (e.g., 122a or 122b in FIG. 1) for a stator (e.g., 120a or 120b in FIG. 1).

A configuration with 12 cores (312) comprises 12 sets of the motor/oscillator coil (e.g., 121a or 121b in FIG. 1), the copper plate (e.g., 125a or 125b in FIG. 1), and the generator coil (e.g., 122a or 122b in FIG. 1) for a stator (e.g., 120a or 120b in FIG. 1).

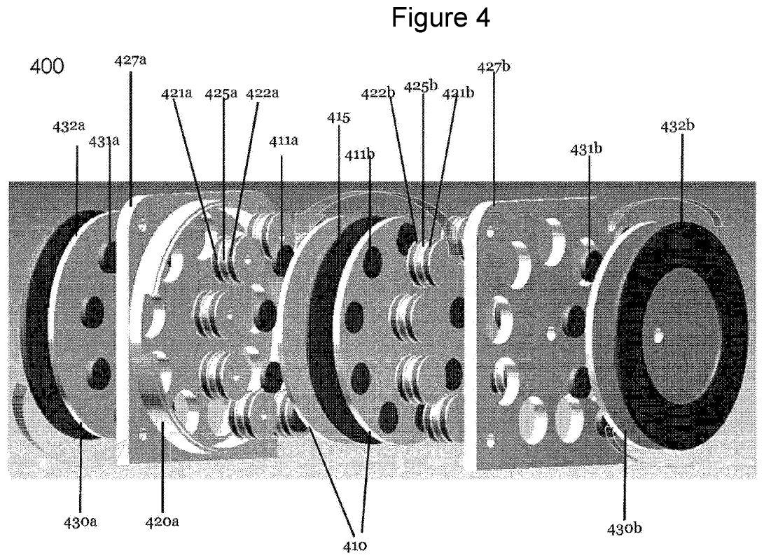

A 3-dimensional depiction of an apparatus and system with a 12-core configuration (400) is shown in FIG. 4, where the numbers of the comprising components correspond to the numbers of the components in FIG. 1. For example, the comprising component (430a) in FIG. 4 is the secondary rotor (130a) in FIG. 1.

The comprising component 432a in FIG. 4 maps to the component 132a in FIG. 1; the component 430a in FIG. 4 maps to the component 130a in FIG. 1; the component 431a in FIG. 4 maps to the component 131a in FIG. 1; the component 420a in FIG. 4 maps to the component 120a in FIG. 1; the component 415 in FIG. 4 maps to the component 115 in FIG. 1; and so on.

The present invention is not limited to the features, structures, and effects described in the above embodiments. Furthermore, the features, structures, and effects in each embodiment may be combined or modified by those skilled in the art. Accordingly, it should be interpreted that contents relating to such combinations and modifications are included in the scope of the present invention.

While this invention has been particularly shown and described with reference to preferred embodiments thereof, it will be understood by those skilled in the art that various changes in form and details may be made therein without departing from the spirit and scope of the invention as defined by the appended claims. For example, each component in an embodiment is modified and implemented. Accordingly, it should be interpreted that differences relating to such modifications and applications are included in the scope of the appended claims.

1. An autonomous electric generator comprising:
a stator includes generator coil for generating electricity and motor coil for generating electromagnetic force;
a primary rotator includes a first permanent magnet; and
a secondary rotator includes a second permanent magnet,
wherein the primary rotator and secondary rotator are rotated by the electromagnetic force generated by the motor coil.

2. The autonomous electric generator according to claim 1, further comprising:
a capacitor provides electricity generated by the generator coil.

3. The autonomous electric generator according to claim 1,
wherein the primary rotator and the secondary rotator include a magnetic shield for shielding magnetic lines of force created by the permanent magnet.

4. The autonomous electric generator according to claim 3,
wherein the magnetic shield is iron plate.

5. The autonomous electric generator according to claim 3,
wherein the magnetic shield of the secondary rotor and the magnetic shield of the primary rotor create shielded spaces of magnetic fields to create the condensed magnetic lines of forces between the magnetic shields.

6. The autonomous electric generator according to claim 1,
wherein the motor coil generates oscillating frequency the matches a intrinsic quantum property of a intrinsic angular momentum of a isotopes included in a permanent magnet.

7. The autonomous electric generator according to claim 1, further comprising:
a rechargeable battery for storing electric energy generated by the generator coil, and regulating the generated electric energy.
